(19) United States
(12) Patent Application Publication
(10) Pub. No.: US 2010/0083467 A1
(43) Pub. Date: Apr. 8, 2010

(54) Portable Electronic Device and Hinge Module Thereof

(75) Inventors: Pao-Tung Weng, Taipei (TW); Chih-Ho Hsieh, Taipei (TW); Mei-Fan Chou, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/548,541

(22) Filed: Aug. 27, 2009

(30) Foreign Application Priority Data
Oct. 6, 2008 (TW) 97138425

(51) Int. Cl. E05F 1/10; E05F 1/08

(52) U.S. Cl. 16/308; 16/277

(57) ABSTRACT

A portable electronic device includes a main portion, a display portion and a hinge module. The display portion is pivotally connected with the main portion by the hinge module. A first hinge member has one end secured to the main portion. A second hinge member has one end, pivotally connected with the other end of the first hinge member, and the other end secured to the display portion, wherein the second hinge member comprises a guide slot. A resilient member is disposed around the other end of the first hinge member. The resilient member includes a fastening end and an actuation end. The fastening end is secured to the first hinge member. The actuation end is disposed within the guide slot of the second hinge member. The guide slot is operable to drive the actuation end so as to deform the resilient member.

### RELATED APPLICATIONS

This application claims priority to Taiwan Application Serial Number 97138425, filed Oct. 6, 2008, which are herein incorporated by reference.

### BACKGROUND

1. Field of Invention

The present invention relates to an electronic device. More particularly, the present invention relates to a portable electronic device.

2. Description of Related Art

When a display portion of a conventional portable electronic device (e.g. a notebook computer) is swiveled or unfolded away from a main portion thereof, the portable electronic device as a whole may be swiveled accordingly unless the main portion is otherwise held firmly (e.g. the main portion is held by one hand while the display portion is swiveled by the other hand). In case the friction torque of the hinge interconnecting the main portion and the display portion is reduced, the display portion may not be safely operated at several particular positions.

### SUMMARY

It is therefore an objective of the present invention to provide a portable electronic device and a hinge module thereof so as to permit a display portion thereof to be swiveled conveniently and safely.

In accordance with the foregoing and other objectives of the present invention, a portable electronic device includes a main portion, a display portion and a hinge module. The display portion is pivotally connected with the main portion by the hinge module. A first hinge member has one end secured to the main portion. A second hinge member has one end, pivotally connected with the other end of the first hinge member, and the other end secured to the display portion, wherein the second hinge member comprises a guide slot. A resilient member is disposed around the other end of the first hinge member. The resilient member includes a fastening end and an actuation end. The fastening end is secured to the first hinge member. The actuation end is disposed within the guide slot of the second hinge member. The guide slot is operable to drive the actuation end so as to deform the resilient member.

In accordance with the foregoing and other objectives of the present invention, a hinge module includes a first hinge member, a second hinge member and a resilient member. The second hinge member has one end, pivotally connected with the one end of the first hinge member, and has a guide slot. The resilient member is disposed around the end of the first hinge member. The resilient member includes a fastening end and an actuation end. The fastening end is secured to the first hinge member. The actuation end is disposed within the guide slot of the second hinge member. The guide slot is operable to drive the actuation end so as to deform the resilient member.

Thus, the present invention provides a portable electronic device, which is equipped with a varied-torque hinge module being operable to provide a proper torque at different swivel positions, for a user to conveniently and safely swivel a display portion of the portable electronic device.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a portable electronic device according to one preferred embodiment of this invention;

FIG. 2 illustrates an exploded view of a hinge module according to one preferred embodiment of this invention; and

FIGS. 3-6 respectively illustrate four position statuses of the portable electronic device's hinge module according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

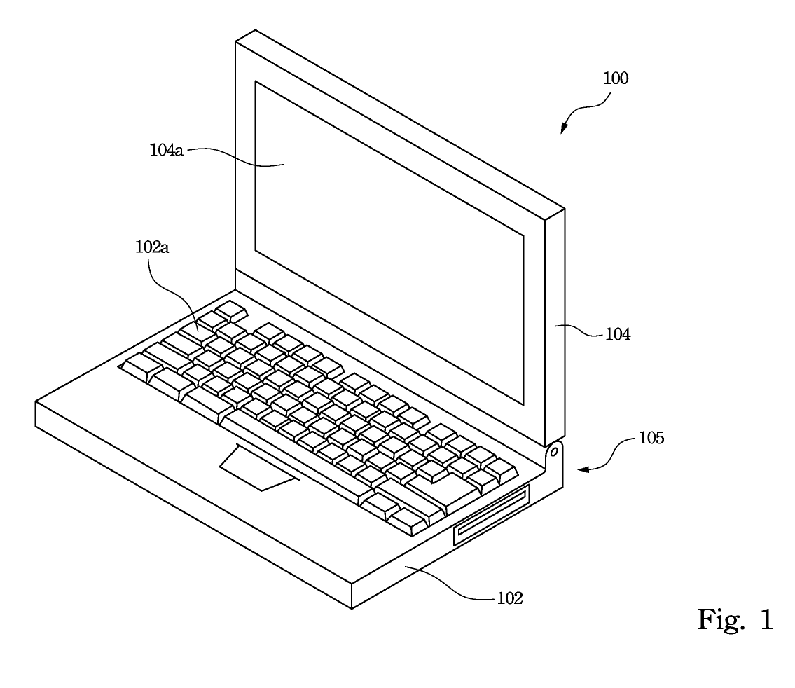

FIG. 1 illustrates a perspective view of a portable electronic device according to one preferred embodiment of this invention. The portable electronic device 100 consists of a main portion 102 and a display portion 104. The display portion 104 is pivotally connected with the main portion 102 by a rotation portion 105 such that the display portion 104 can be swiveled relative to the main portion 102 to be folded against or unfolded away the main portion 102. In this embodiment, the rotation portion 105 provides a proper torque for the display portion 104 at different position (relative to the main portion 102) such that the display portion 104 can be conveniently and safely swiveled by users. The display portion has a display screen 104a while the main portion has a keyboard 102a.

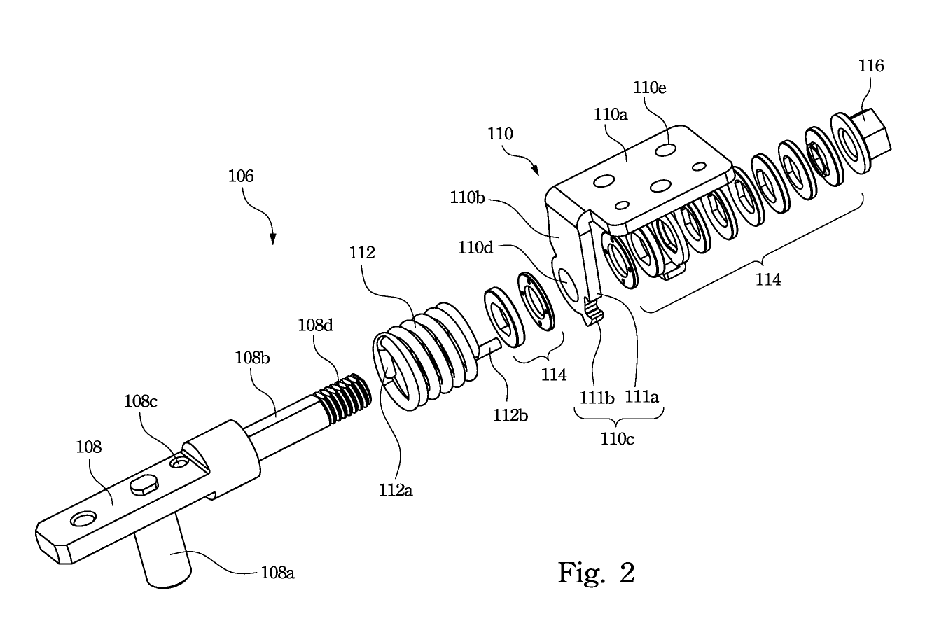

FIG. 2 illustrates an exploded view of a hinge module according to one preferred embodiment of this invention. The hinge module 106 is located within the rotation portion 105 (as illustrated in FIG. 1). The hinge module 106 includes a first hinge member 108, a second hinge member 110, a resilient member 112 (such as a torsion spring), several washers 114 and a screw nut 116.

When all parts of the hinge module 106 are assembled, the resilient member 112 is arranged around a rod end 108b of the first hinge member 108. The resilient member 112 has a fastening end 112a inserted into a positioning hole 108c. Next, the washers 114 and the second hinge member 110 are also arranged around the rod end 108b of the first hinge member 108, i.e. the rod end 108b of the first hinge member 108 is led through holes of all the washers 114 and the second hinge member 110. A flat member 110b of the second hinge member 110 has a through hole 110d through which the rod end 108b of the first hinge member 108 is led. The screw nut 116 is then screwed onto a threaded portion 108d of the rod end 108b of the first hinge member 108 such that all parts of the hinge module 106 are properly secured. After the hinge module 106 has been assembled, the resilient member 112 has an actuation end 112b located within a guide slot 110c of the second hinge member 110. The guide slot 110c has a first sidewall 111a and a second sidewall 111b disposed oppositely, between which the actuation end 112b of the resilient member 112 can be freely swiveled. The guide slot 110c can be a position-restricting slot or position-guiding slot. In this embodiment, the washers 114 can be metal resilient members or other washers, which is able to provide friction torques.

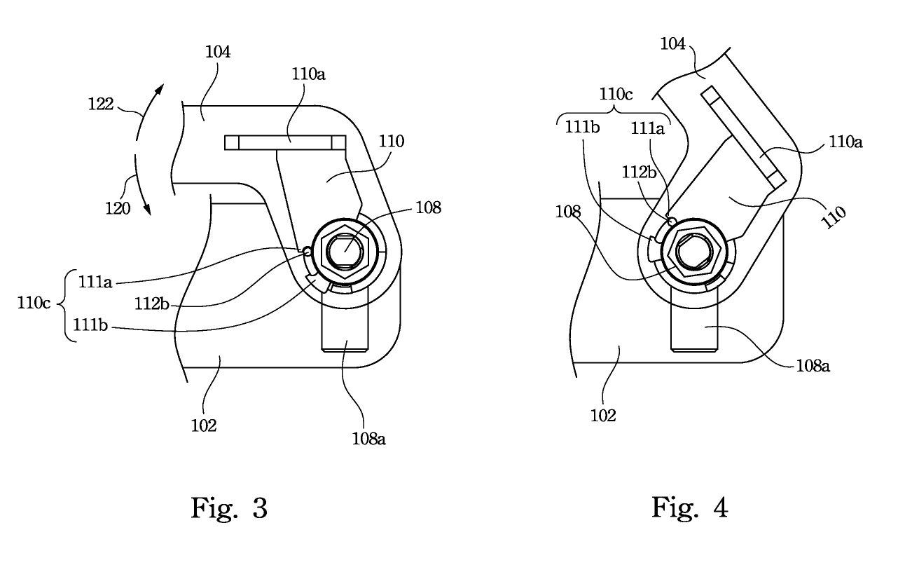

Referring to both FIG. 2 and FIG. 3, the first hinge member 108 has one end 108a secured to the main portion 102 while the second member 110 has one end 110a secured to the display portion 104 (by fastening the end 110a to the display portion 104 through the screw holes 110e) in the assembled hinge module 106. Therefore, the display portion 104 can be swiveled relative to the main portion 102 by means of the hinge nodule 106.

In this embodiment, the friction between the contacted washers 114 forms a constant torque for the hinge module 106 while the resilient member 112 is able to increase or decrease the constant torque for the hinge module 106 according to deformed amount of the resilient member 112. The deformed amount of the resilient member 112 is generated by a relative rotation amount between the first hinge member 108 and the second hinge member 110.

FIGS. 3-6 respectively illustrate four position statuses of the portable electronic device's hinge module according to one preferred embodiment of this invention.

In FIG. 3, the second hinge member 110 is at a first position relative to the first hinge member 108, and the display portion 104 is approximately folded against the main portion 102 in this case. When the display portion 104 is folding against the main portion 102 along a direction 120, the first sidewall 111a of the guide slot 110c would drive the actuation end 112b to cause a deformation upon the resilient member 112. Such deformation of the resilient member 112 would reduce the possibility of the display portion 104 violently hitting the main portion 102 when the display portion 104 is folding against the main portion 102. In contrast, such deformation recovery of the resilient member 112 would enable the actuation end 112b to drive the first sidewall 111a of the guide slot 110c when the display portion 104 is unfolding away from the main portion 102 along a direction 122. Therefore, a smaller force is needed (by a user) to unfold the display portion 104 away from the main portion 102. The resilient member 112 may be specifically dimensioned and/or made from specific materials such that the resilient member 112 provides a larger torque (generated by deformation) than the constant friction torque of the contacted washers 114 when the display portion 104 is completely folded against the main portion 102. In this case, the display portion 104 would automatically pop up when the display portion 104 is released (or unlocked) from the main portion 102.

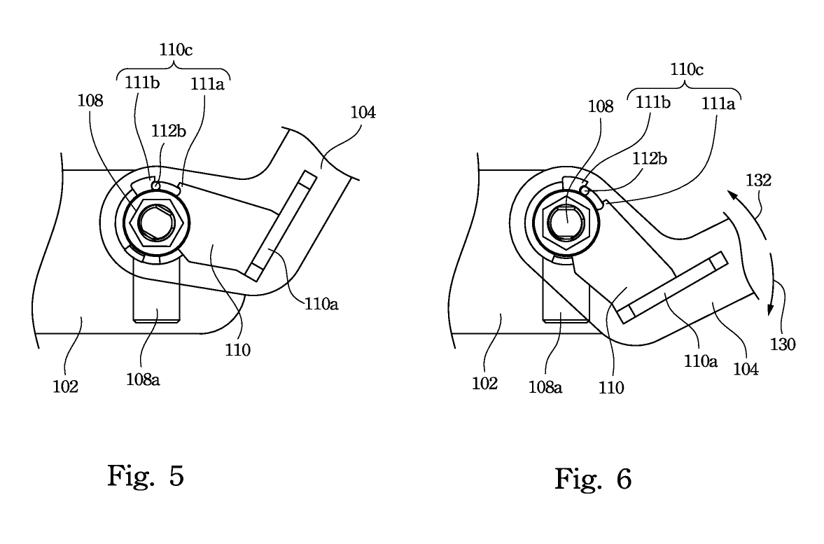

In FIG. 4 and FIG. 5, the second hinge member 110 is at a second position and a third position relative to the first hinge member 108, and the display portion 104 is substantially upright relative to the main portion 102 in this case. The range between the second and third position of the second hinge member 110 provides the display portion 104 a better display view for a user in normal cases. When the second hinge member 110 is between a second position and a third position relative the first hinge member 108, this is, the actuation end 112b of the resilient member 112 departs from the first sidewall 111a and contacts the second sidewall 111b, the hinge module 106 provides a constant torque. The rotation range of the constant torque is the range of the guide slot 110c within which the actuation end 112b of the resilient member 112 can be freely swiveled. In this freely-swiveled range, the resilient member 112 is free from deformation, and its actuation end 112b is not restricted by the first sidewall 111a or the second sidewall 111b of the guide slot 110c. The freely-swiveled range of the guide slot 110c can be varied and predetermined according to actual demands. That is, the guide slot 110c is such dimensioned that the actuation end 112b is freely swiveled within a predetermined range of the guide slot 110c.

In FIG. 6, the second hinge member 110 is at a fourth position relative to the first hinge member 108, and the display portion 104 is unfolded far away from the main portion 102 in this case, i.e. the display portion 104 is close to a table surface or a support surface. When the display portion 104 is unfolding away from the main portion 102 along a direction 130, the second sidewall 111b of the guide slot 110c would drive the actuation end 112b to cause a deformation upon the resilient member 112. Such deformation of the resilient member 112 would reduce the possibility of the display portion 104 violently hitting the table surface or the support surface when the display portion 104 is unfolding away from the main portion 102. In contrast, such deformation recovery of the resilient member 112 would enable the actuation end 112b to drive the second sidewall 111b of the guide slot 110c when the display portion 104 is folding close to the main portion 102 along a direction 132. Therefore, a smaller force is needed (by a user) to fold the display portion 104 close to the main portion 102.

According to discussed embodiments, the present invention provides a portable electronic device, which is equipped with a varied-torque hinge module being operable to provide a proper torque at different swivel positions, for a user to conveniently and safely swivel a display portion of the portable electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable electronic device, comprising:
a main portion;
a display portion; and
a hinge module by which the display portion is pivotally connected with the main portion, the hinge module comprising:
a first hinge member having one end secured to the main portion;
a second hinge member having one end pivotally connected with the other end of the first hinge member, and the other end secured to the display portion, wherein the second hinge member comprises a guide slot; and
a resilient member disposed around the other end of the first hinge member, the resilient member comprising a fastening end and an actuation end, the fastening end being secured to the first hinge member, the actuation end being disposed within the guide slot of the second hinge member, the guide slot being operable to drive the actuation end so as to deform the resilient member.

2. The portable electronic device of claim 1, further comprising a plurality of washers disposed around the other end of the first hinge member.

3. The portable electronic device of claim 1, wherein the resilient member is a torsion spring.

4. The portable electronic device of claim 1, wherein the guide slot comprises a first sidewall and a second sidewall disposed oppositely to deform the resilient member.

5. The portable electronic device of claim 4, wherein the first sidewall drives the actuation end of the resilient member to deform the resilient member when the second hinge member is at a first position relative the first hinge member.

6. The portable electronic device of claim 4, wherein the actuation end of the resilient member departs from the first sidewall and contacts the second sidewall when the second hinge member rotates from a second position to a third position relative the first hinge member.

7. The portable electronic device of claim 4, wherein the second sidewall drives the actuation end of the resilient member to deform the resilient member when the second hinge member is at a fourth position relative the first hinge member.

8. The portable electronic device of claim 1, wherein the guide slot is such dimensioned that the actuation end is freely swiveled within a predetermined range of the guide slot.

9. A hinge module comprising:
a first hinge member;
a second hinge member having one end, pivotally connected with the one end of the first hinge member, and having a guide slot; and
a resilient member disposed around the end of the first hinge member, the resilient member comprising a fastening end and an actuation end, the fastening end being secured to the first hinge member, the actuation end being disposed within the guide slot of the second hinge member, the guide slot being operable to drive the actuation end so as to deform the resilient member.

10. The hinge module of claim 9, further comprising a plurality of washers disposed around the end of the first hinge member.

11. The hinge module of claim 9, wherein the resilient member is a torsion spring.

12. The hinge module of claim 9, wherein the guide slot is such dimensioned that the actuation end is freely swiveled within a predetermined range of the guide slot.

13. The hinge module of claim 9, wherein the guide slot comprises a first sidewall and a second sidewall disposed oppositely to deform the resilient member.

14. The hinge module of claim 13, wherein the first sidewall drives the actuation end of the resilient member to deform the resilient member when the second hinge member is at a first position relative the first hinge member.

15. The hinge module of claim 13, wherein the actuation end of the resilient member departs from the first sidewall and contacts the second sidewall when the second hinge member is between a second position and a third position relative the first hinge member.

16. The hinge module of claim 13, wherein the second sidewall drives the actuation end of the resilient member to deform the resilient member when the second hinge member is at a fourth position relative the first hinge member.
